(19) United States
(12) Patent Application Publication
(10) Pub. No.: US 2024/0177887 A1
(43) Pub. Date: May 30, 2024

(54) CORE WIRE AND METHOD OF MAKING SAME AND CABLE INCLUDING THE CORE WIRE

(71) Applicant: FOXCONN (KUNSHAN) COMPUTER CONNECTOR CO., LTD., Kunshan (CN)

(72) Inventors: CHUN-LIN LEE, New Taipei (TW); Jian-Guo Cai, Kunshan (CN); Juan Zheng, Kushan (CN); Lu-Yu Chang, New Taipei (TW)

(73) Assignee: FOXCONN INTERCONNECT TECHNOLOGY LIMITED, Grand Cayman (KY)

(21) Appl. No.: 18/518,977

(22) Filed: Nov. 25, 2023

(30) Foreign Application Priority Data
Nov. 25, 2022 (CN) 202211491440.2

(51) Int. Cl. H01B 7/02; H01B 1/02; H01B 5/12; H01B 13/22

(52) U.S. Cl. CPC H01B 7/0258; H01B 1/026; H01B 5/12; H01B 13/228

(57) ABSTRACT

A core wire includes: an inner conductor; and an insulating layer covering the inner conductor, wherein the insulation layer is made by 3D printing process, the insulating layer includes a first semi-insulating layer and a second semi-insulating layer, each of the first semi-insulating layer and the second semi-insulating layer has a groove that matchingly accommodates the shape of the inner conductor, and the first semi-insulating layer and the second semi-insulating layer are combined together.

### BACKGROUND OF THE INVENTION

### Field of the Invention

The present invention relates generally to a core wire for a cable, and method of making the same, and a cable including the core wire, and more particularly to a core wire that has good electrical performance to transmit high- frequency signals.

### Description of Related Arts

With the development and popularization of electronic technology products, cables are widely used in household appliances, instrumentation, automation equipment, data centers, servers, switches, cloud computing and 5G as a tool for signal transmission. The core wire of a cable generally includes an inner conductor for transmitting signals and an insulating layer formed outside the inner conductor. Two traditional foaming methods commonly used for insulating layers are chemical foaming and physical foaming to reduce the dielectric coefficient and size of the cable. However, for the insulating layer produced by traditional foaming, the maximum air content in the insulating layer can only reach about 35%, and the foaming may be uneven as to affect stability of high-frequency signal transmission.

Therefore, it is necessary to provide a core wire in which the transmission of high-speed signals is more stable.

### SUMMARY OF THE INVENTION

A main object of the present invention is to provide a core wire suitable for transmitting high-speed signals, and a method of making the same, and a cable including the core wire.

To achieve the above object, a core wire comprises: an inner conductor; and an insulating layer covering the inner conductor, wherein the insulation layer is made by 3D printing process, the insulating layer includes a first semi-insulating layer and a second semi-insulating layer, each of the first semi-insulating layer and the second semi-insulating layer has a groove that matchingly accommodates the shape of the inner conductor, and the first semi-insulating layer and the second semi-insulating layer are combined together.

To achieve the above object, a method of making a core wire comprises the steps of: 3D printing a first semi-insulating layer of an insulating layer with a first groove; 3D printing a second semi-insulating layer of the insulating layer with a second groove; receiving an inner conductor in the he first groove and the second groove; and combining the first semi-insulating layer and the second semi-insulating layer together to form the core wire.

To achieve the above object, a cable comprises a core wire having an inner conductor and an insulating layer covering the inner conductor, wherein the insulating layer is made by 3D printing, the insulating layer includes a first semi-insulating layer and a second semi-insulating layer, each of the first semi-insulating layer and the second semi-insulating layer has a groove that matchingly accommodates the shape of the inner conductor, and the first semi-insulating layer and the second semi-insulating layer are combined together.

Compared to prior art, insulating layer of the core wire of the present invention is made by 3D printing, which makes the air content in the insulating layer higher, the dielectric coefficient smaller, and the distribution of air in the insulating layer more uniform. Also the size of the cable can be smaller while ensuring impedance matching, and the electrical and mechanical characteristics are further improved.

### BRIEF DESCRIPTION OF THE DRAWING

FIG. 1 is a perspective view of a core wire according to the present invention; and

FIG. 2 is a cross-sectional view of the core wire of FIG. 1.

### DETAILED DESCRIPTION OF THE PREFERRED EMBODIMENT

In twinaxial cables, D represents the diameter of the inner conductor, S represents the distance from the center of one inner conductor of a pair of core wires to the center of the other inner conductor. In traditional twinaxial cables, S is usually equal to or greater than 2 times OD (the diameter of a single conductor) to ensure proper impedance matching.

the formula for impedance is

$${Z}_{diff} = \frac{120}{\sqrt{\text{?}}} ln ( \frac{2 S}{D} )$$

$$\text{?} \text{indicates text missing or illegible when filed}$$

wherein Z_{diff} represents the impedance, and εᵣ represents the dielectric constant. When the impedance Z, inner conductor diameter, and other conditions remain unchanged, only the foaming conditions are different. The distance between the centers of a pair of inner conductors under different foaming conditions can be derived. When the insulating layer material is solid PTFE, the distance between the centers of a pair of inner conductors is S1, then

When the foaming rate is 30%, the distance between the centers of the pair of inner conductors S=0.88×S1;

When the foaming rate is 50%, the distance between the center of the pair of inner conductors is S=0.82×S1;

When the foaming rate is 80%, the distance between the centers of a pair of inner conductors is S=0.74×S1;

When the foaming rate is 100%, the distance between the centers of a pair of inner conductors is S=0.69×S1.

It can be seen from the above calculation that when the impedance matching remains unchanged, the more air content inside the insulating layer, the smaller the overall size of the cable can be. When the foaming rate is 30% to 80%, the distance between the centers of a pair of inner conductors can be reduced to 74% to 88% of the distance between the center points of a pair of inner conductors without foaming.

The formula for signal transmission speed v is

$$v = \frac{C}{\sqrt{\text{?}}}$$

$$\text{?} \text{indicates text missing or illegible when filed}$$

wherein εᵣ represents the dielectric constant, and C represents the speed of light. It can be seen that the dielectric constant can affects the transmission speed. The dielectric constant of air is 1.0, so using air as the insulating layer, the transmission speed of the signal is equal to the speed of light. The dielectric constant of solid PTFE is 2.1, so the signal transmission speed in solid PTFE is 0.69 times the speed of light. Adding air to the insulating layer can reduce the dielectric constant, allowing signals to be transmitted faster. Other conditions remain unchanged, the insulating layer material is PTFE, only the foaming conditions are different, the signal transmission speed is calculated as follows:

When not foaming, the signal transmission speed v=0.69×C;

When the foaming rate is 30%, the signal transmission speed v=0.77×C

When the foaming rate is 50%, the signal transmission speed v=0.83×C

When the foaming rate is 80%, the signal transmission speed v=0.93×C

It can be seen that the more air content in the insulating layer, the faster the signal transmission speed will be.

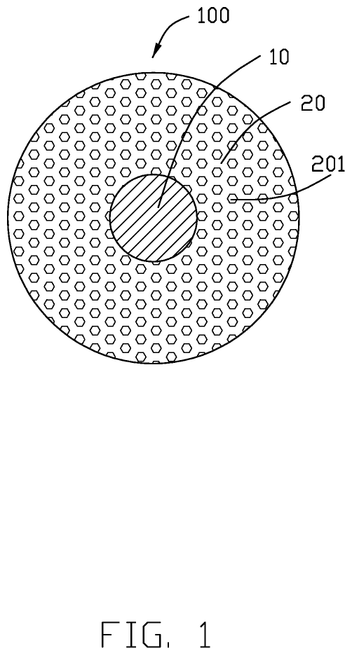

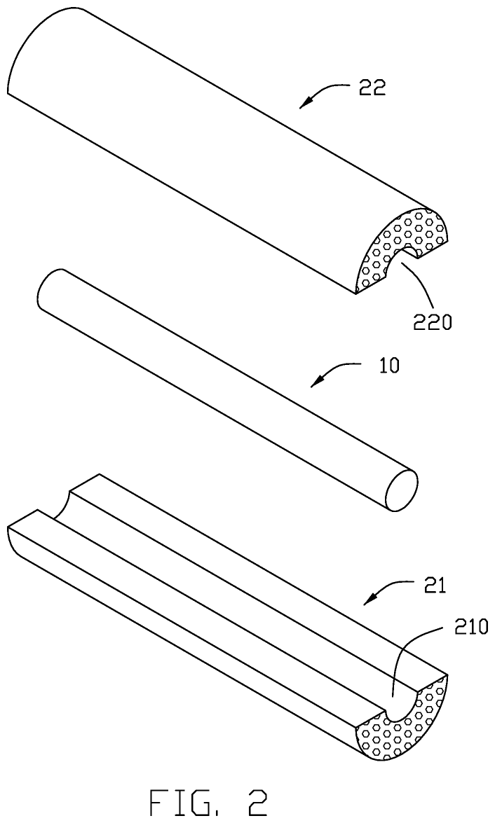

Referring to FIGS. 1-2, a core wire 100 in accordance with the present invention is shown. The core wire 100 includes an inner conductor 10 and an insulating layer 20 covering the inner conductor. The inner conductor 10 is selected from the group consisting of copper inner conductor, silver-plated copper inner conductor, and tin-plated copper inner conductor. The inner conductor 10 may be one piece, or the inner conductor 10 may be formed by twisting multiple conductors. Specifically, in this embodiment, the inner conductor 10 takes one conductor as an example. The inner insulating layer 20 can be one of solid PP (polypropylene), solid PE (polyethylene), solid FEP (Fluorinated ethylene propylene), foamed PE, foamed PP, foamed FEP, and solid PTFE (Polytetrafluoroethene). Of course, the insulating layer 20 can also be made of other suitable materials. The insulating layer 20 is made by 3D printing. The air 201 content in the insulating layer 20 is greater than 35%. Specifically, in the present invention, the content of air 201 in the insulating layer 20 is between 35% and 80%. The insulating layer 20 includes a first semi-insulating layer 21 and a second semi-insulating layer 22. The first semi-insulating layer 21 has a first groove 210, and the second semi-insulating layer 22 has a second groove 220. The shape of the first groove 210 and the second groove 220 matches the shape of the inner conductor 10. The inner conductor 10 can be received in the first groove 210 and the second groove 220. The first semi-insulating layer 21 and the second semi-insulating layer 22 can be bonded together by glue or can be buckled together, or can be welded together by ultrasonic welding. The first semi-insulating layer 21 and the second semi-insulating layer 22 can also be combined in other ways.

A method of making the core wire 100, comprising the steps of: 3D printing the first semi-insulating layer 21 of the insulating layer 20 with the first groove 210; 3D printing the second semi-insulating layer 22 of the insulating layer 20 with the second groove 210; receiving the inner conductor 10 in the he first groove 210 and the second groove 220; and combining the first semi-insulating layer 21 and the second semi-insulating layer 22 together to form the core wire 100.

In the present invention, first, 3D print the first semi-insulating layer 21 and the second semi-insulating layer 22 of a preset length, then the inner conductor 10 is assembled in the first semi-insulating layer 21 and the second semi-insulating layer 22, finally, the first semi-insulating layer 21 and the second semi-insulating layer 22 are combined together. In other embodiments, the insulating layer can also be directly formed and wrapped around the inner conductor through 3D printing process.

A cable made of the core wire 100 of the present invention may include a pair of the core wires 100. The distance between the centers of the inner conductors 10 of a pair of core wires 100 is less than 2 times the diameter of a single conductor 10. The cable also includes a shielding layer (not shown) and an outer sheath (not shown) covering the shielding layer.

The insulating layer 20 of the core wire 100 of the present invention is made by 3D printing. The air 201 content in the insulating layer 20 is higher and the dielectric coefficient is small, so that the size of the cable can be smaller while ensuring impedance matching, and the air distribution in the insulating layer 20 is more uniform, which has more advantages than the traditional melt extrusion process, and the electrical characteristics and mechanical characteristics are further improved.

1. A core wire comprising:
an inner conductor; and
an insulating layer covering the inner conductor, wherein
the insulation layer is made by 3D printing process, the insulating layer includes a first semi-insulating layer and a second semi-insulating layer, each of the first semi-insulating layer and the second semi-insulating layer has a groove that matchingly accommodates the shape of the inner conductor, and the first semi-insulating layer and the second semi-insulating layer are combined together.

2. The core wire as claimed in claim 1, wherein the first semi-insulating layer and the second semi-insulating layer are bonded together by glue, or buckled together, or welded together by ultrasonic.

3. The core wire as claimed in claim 1, wherein the air content in the insulating layer is greater than 35%.

4. The core wire as claimed in claim 1, wherein the air content in the insulating layer is between 35% and 80%.

5. The core wire as claimed in claim 1, wherein the inner conductor is selected from the group consisting of copper inner conductor, silver-plated copper inner conductor, and tin-plated copper inner conductor.

6. The core wire as claimed in claim 1, wherein the inner insulating layer is selected from the group consisting of solid PP, solid PE, solid FEP, foamed PE, foamed PP, foamed FEP, and solid PTFE.

7. The core wire as claimed in claim 1, wherein the inner conductor is formed by twisting multiple conductors.

8. A method of making a core wire, comprising the steps of:
3D printing a first semi-insulating layer of an insulating layer with a first groove;
3D printing a second semi-insulating layer of the insulating layer with a second groove; and
receiving an inner conductor in the first groove and the second groove; and
combining the first semi-insulating layer and the second semi-insulating layer together to form the core wire.

9. A cable comprising:
a core wire comprising:
an inner conductor; and
an insulating layer covering the inner conductor, wherein
the insulating layer is made by 3D printing, the insulating layer includes a first semi-insulating layer and a second semi-insulating layer, each of the first semi-insulating layer and the second semi-insulating layer has a groove that matchingly accommodates the shape of the inner conductor, and the first semi-insulating layer and the second semi-insulating layer are combined together.

10. The cable as claimed in claim 9, wherein the cable includes a pair of core wires, and the distance between a center distance of the inner conductors of the pair of core wires is less than two times the diameter of a single inner conductor.
